(19) United States
(12) Patent Application Publication
(10) Pub. No.: US 2026/0367746 A1
(43) Pub. Date: Nov. 19, 2026

(54) PROXIMITY-BASED DISPLAY TECHNOLOGY

(71) Applicants: Joe Johnston; Joli Murtha

(72) Inventors: Joe Johnston; Joli Murtha

(21) Appl. No.: 19/208,700

(22) Filed: May 15, 2025

(51) Int. Cl. G06F 3/0481; G06K 7/14; G06Q 30/0241; G06V 20/52

(52) U.S. Cl. CPC G06F 3/0481; G06K 7/1417; G06Q 30/0277; G06V 20/52

(57) ABSTRACT

Systems, apparatuses, and computer-implemented methods provide for technology that presents content in a first region of a display, wherein the content is presented at a first scroll frequency in response to a first determination based on one or more signals from a camera that an individual is located at a first distance from the display, and presents the content in the first region of the display at a second scroll frequency in response to a second determination based on the one or more signals from the camera that the individual is located at a second distance from the display, wherein the second distance is less than the first distance, and wherein the second scroll frequency is less than the first scroll frequency.

### TECHNICAL FIELD

Embodiments generally relate to displays. More particularly, embodiments relate to proximity-based display technology.

### BACKGROUND

Displays are used to convey information in a wide variety of settings and the information is typically pre-selected (e.g., based solely on pre-set programming guidelines and/or schedules). Accordingly, the information may not be useful or relevant to individuals viewing the display at any given moment.

### SUMMARY

In one embodiment, a performance-enhanced system comprises a display, a camera, a processor coupled to the display and the camera, and a memory coupled to the processor, the memory including a plurality of executable program instructions, which when executed by the processor, cause the processor to present content in a first region of the display, wherein the content is presented at a first scroll frequency in response to a first determination based on one or more signals from the camera that an individual is located at a first distance from the display, and present the content in the first region of the display at a second scroll frequency in response to a second determination based on the one or more signals from the camera that the individual is located at a second distance from the display, wherein the second distance is less than the first distance, and wherein the second scroll frequency is less than the first scroll frequency.

In another embodiment, at least one computer readable storage medium comprising a plurality of executable program instructions, which when executed by a processor, cause the processor to present content in a first region of a display, wherein the content is presented at a first scroll frequency in response to a first determination based on one or more signals from a camera that an individual is located at a first distance from the display, and present the content in the first region of the display at a second scroll frequency in response to a second determination based on the one or more signals from the camera that the individual is located at a second distance from the display, wherein the second distance is less than the first distance, and wherein the second scroll frequency is less than the first scroll frequency.

In another embodiment, a method of operating a display comprises presenting content in a first region of a display, wherein the content is presented at a first scroll frequency in response to a first determination based on one or more signals from a camera that an individual is located at a first distance from the display, and presenting the content in the first region of the display at a second scroll frequency in response to a second determination based on the one or more signals from the camera that the individual is located at a second distance from the display, wherein the second distance is less than the first distance, and wherein the second scroll frequency is less than the first scroll frequency.

### DRAWINGS

The various advantages of the exemplary embodiments will become apparent to one skilled in the art by reading the following specification and appended claims, and by referencing the following drawings, in which:

FIG. 1 is an illustration of an example of a content delivery ecosystem according to an embodiment;

FIG. 2 is an illustration of an example of a plurality of regions on a display according to an embodiment;

FIGS. 3A-3C are plan views of an example of a plurality of viewing areas at various proximity stages according to an embodiment;

FIG. 4 is an illustration of an example of information being simultaneously displayed in a plurality of regions on a display based on proximity according to an embodiment;

FIG. 5 is an illustration of an example of personalized content being presented in an entirety of a display based on proximity according to an embodiment;

FIGS. 6 and 7 are flowcharts of examples of methods of operating a display according to an embodiment; and

FIG. 8 is a block diagram of an example of a performance-enhanced system according to an embodiment.

### DETAILED DESCRIPTION

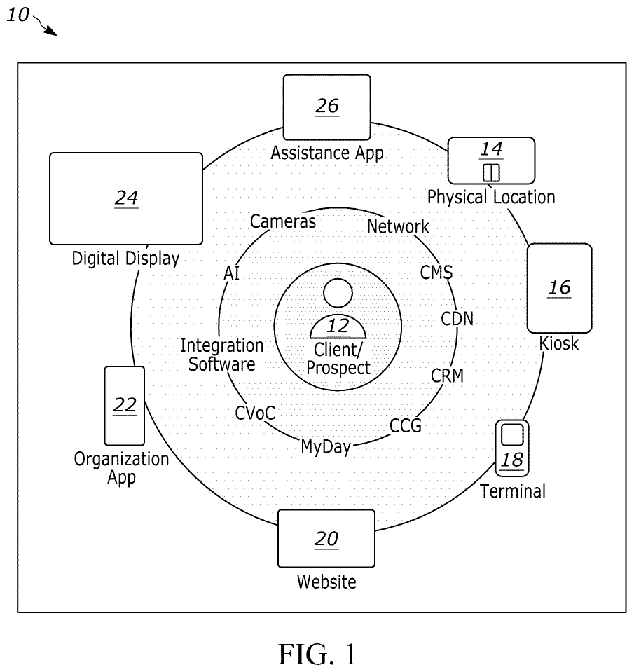

Turning now to FIG. 1, a content delivery ecosystem 10 is shown in which an individual 12 (e.g., client or prospective client of an organization) is in a physical location 14 (e.g., lobby of a bank branch, telecommunications provider, repair shop, doctor's office, etc.) that is supported by several components such as, for example, a kiosk 16 (e.g., self-service), a terminal 18 (e.g., automated teller machine/ATM), a website 20, an organization application 22 (“app”), a digital display 24, an assistance app 26 (e.g., “lobby leader” app), and so forth. Interactions within the content delivery ecosystem 10 can be facilitated by cameras, a network, CMS (content management system), a content delivery network (CDN), a customer relationship manager (CRM), a CCG (Caring Conversation Guide, e.g., delivering guided conversations with clients), MYDAY (e.g., unified calendar), CVoC (Consolidated View of Client), integration software (e.g., SALESFORCE software), artificial intelligence (AI) technology (e.g., generative large language model/LLM), etc., or any combination thereof.

For example, the assistance app 26 can include tools to assist the individual 12 and foster more meaningful care conversations in the physical location 14 (e.g., gaining access to 360° client details and real-time visibility into who is present). Additionally, the kiosk 16 can enable the individual to 12 to check-in for scheduled appointments or make an appointment with a representative of the organization (e.g., elevating the lobby experience by communicating wait times and setting expectations for service).

As will be discussed in greater detail, the digital display 24 may enhance the experience of the individual 12 with real-time queue updates, personalized product offers, and relevant content such as local weather, traffic, etc. Content presented on the digital display 24 can also include scannable codes (e.g., quick response/QR codes) that provide instant access to products and/or services that are tailored to the individual 12 (e.g., connecting digital exploration to in-lobby interactions).

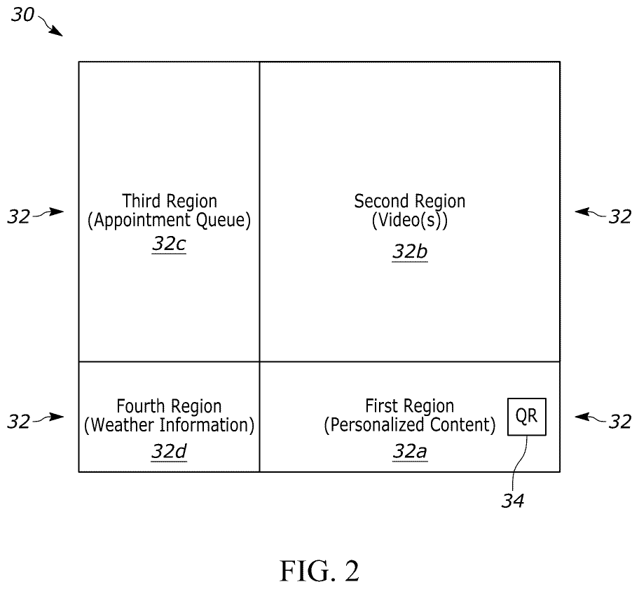

FIG. 2 shows a display 30 that may be readily substituted for the digital display 24 (FIG. 1), already discussed. The display 30 is configured to present information in a plurality of regions 32 (32a-32d) based on individual proximity to the display 30. For example, content presented in a first region 32a can be personalized to one or more individuals viewing the display 30 and scrolled (e.g., modified) at different frequencies/rates based on the distance of the individual(s) to the display 30. In the illustrated example, the content presented in the first region 32a includes a scannable code 34 that provides instant access to products/services, etc., that are tailored to the individual(s) viewing the display 30 (e.g., taking into consideration national, regional and local parameters). Moreover, when the individual(s) are positioned relatively close to the display 30, the technology described herein can automatically present the personalized content on the entirety of the display 30 for a longer period of time (e.g., relatively low scroll frequency/advertisement update rate).

In one example, one or more videos are presented in a second region 32b (e.g., “hero zone”) of the display 30 while the personalized content is presented in the first region 32a. Additionally, an appointment queue may be presented in a third region 32c of the display 30 while the personalized content is presented in the first region 32a. In an embodiment, weather information is presented in a fourth region 32d (e.g., “travel zone” via an open application programming interface/API) of the display 30 while the personalized content is presented in the first region 32a.

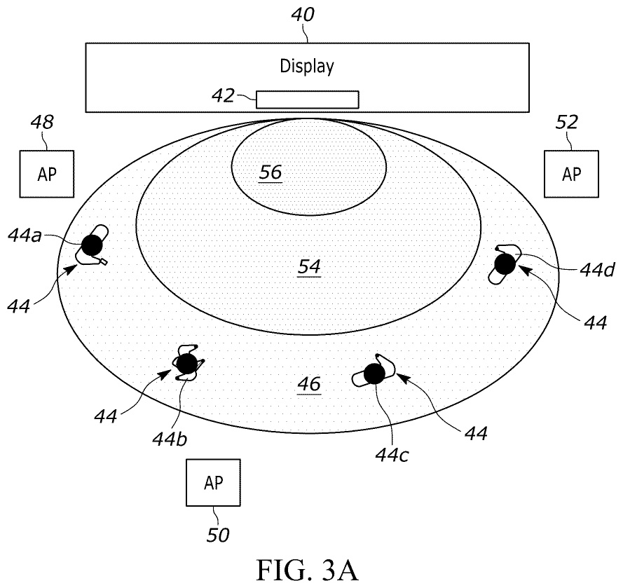

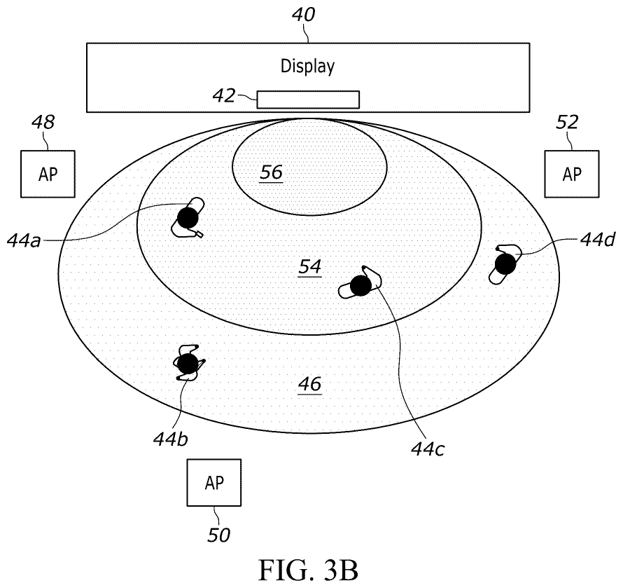

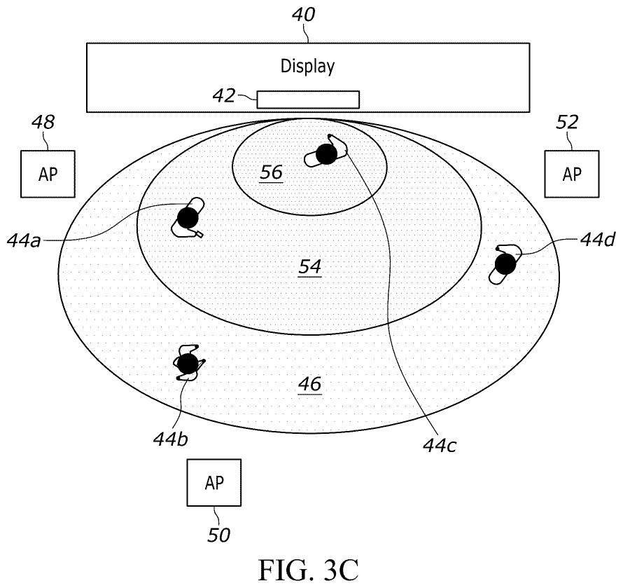

FIG. 3A shows a physical location (e.g., lobby of a bank branch, telecommunications provider, repair shop, doctor's office, etc.) in which a digital display 40 is equipped with a camera 42 (e.g., depth camera). The digital display 30 may be readily substituted for the digital display 24 (FIG. 1) and/or the display 30 (FIG. 2), already discussed. In the illustrated example, a plurality of individuals 44 (44a-44b) are in the physical location. The individuals 44 may be customers/clients and/or potential customers/clients of an organization associated with the physical location. For example, a first individual 44a (e.g., “Williams”) might be interested in setting up a new personal account, a second individual 44b (e.g., “Johnson”) may have an appointment for notary services, a third individual 44c (e.g., “Edwards”) might have an appointment for wealth management services, and a fourth individual 44d (e.g., “Smith”) may have an appointment to discuss an automotive/auto loan. Upon entering the physical location, the first individual 44a can schedule an appointment via a remote kiosk (not shown) such as, for example, the kiosk 16 (FIG. 1) and/or a remote application (not shown) such as, for example, the assistance app 26 (FIG. 1), already discussed. In such a case, appointment data can be transmitted (e.g., wired or wirelessly) from the remote application or kiosk to the display 40, which uses the appointment data to personalize the information presented on the display 40.

In the illustrated stage, all of the individuals 44 are located in a “public” viewing area 46 at a first distance from the display 40. The display 40 uses one or more signals from the camera 42 to detect (e.g., first determination) the presence of the individuals 44 within the public viewing area 46. For example, by using computer vision techniques such as Structure from Motion (SfM) and stereo vision, deep learning technology can estimate the distance to objects in the scene, often involving camera calibration or a known object size as a baseline. In an embodiment, the display 40 also uses triangulation data from a plurality of wireless access points (APs) 48, 50, 52 to determine that the individuals 44 are located within the public viewing area 46. The display 40 may also select and/or modify information to be conveyed via the display based on attribute data associated with the individuals 44.

For example, the attribute data may identify appointment topics (e.g., personal accounts, notary services, wealth management services and auto loan) retrieved from the remote kiosk and/or remote application, wherein the appointment topics are used to select and/or modify personalized content presented in a first region of the display 40 such as, for example, the first region 32a (FIG. 2). The attribute data can also identify a client status (e.g., current client, prospective client, former client) of the individuals 44, wherein the client status is used to select and/or modify the personalized content presented in the first region of the display 40. In an embodiment, current clients are identified as individuals 44 with mobile devices that are logged into an organization app such as, for example, the organization app 22 (FIG. 1), already discussed. Additionally, the rotation/scroll frequency (e.g., advertisement/ad update rate) of the personalized content may be relatively high (e.g., first scroll frequency) while all of the individuals 44 are located within the public viewing area 46 (e.g., at the first distance). As already noted, other information such as videos, an appointment queue, weather information, and so forth, may be concurrently presented on the display 40 while the personalized content is presented in the first region of the display 40.

FIG. 3B shows a subsequent stage in which the first individual 44a (e.g., Williams having an appointment to set up a new account) and the third individual 44c (e.g., Edwards having an appointment for wealth management services) have moved to an “interested” viewing area 54 at a second distance from the display 40, wherein the second distance is less (e.g., closer) than the first distance. Again, the display 40 can use signal(s) from the camera 42 and/or triangulation data from the wireless APs 48, 50, 52 to detect (e.g., second determination) the presence of the first individual 44a and the third individual 44c within the interested viewing area 54.

In one example, the personalized content presented in the first region of the display 40 is selected based on attribute data (e.g., appointment topics, client status) associated with the first individual 44a and the third individual 44c. Additionally, the rotation/scroll frequency of the personalized content may be reduced (e.g., to a second scroll frequency that is less than the first scroll frequency) while the first individual 44a and the third individual 44c are located in the interested viewing area 54 (e.g., to provide more time to read the personalized content). Again, other information such as videos, an appointment queue, weather information, and so forth, may be concurrently presented on the display 40 while the personalized content is presented in the first region of the display 40.

FIG. 3C shows yet another subsequent stage in which the third individual 44c (e.g., Edwards having an appointment for wealth management services) has moved to a “personal” viewing area 56 at a third distance from the display 40, wherein the third distance is less (e.g., closer) than the second distance. The display 40 may use signal(s) from the camera 42 and/or triangulation data from the wireless APs 48, 50, 52 to detect (e.g., third determination) the presence of the third individual 44c within the personal viewing area 56.

As will be discussed in greater detail, the display 40 can automatically present the personalized content in the entirety of the display 40 at a third scroll frequency in response to the third determination, wherein the third scroll frequency is less (e.g., slower) than the second scroll frequency (e.g., providing even more time to read the personalized content). In an embodiment, the personalized content is selected based on attribute data (e.g., appointment topics, client status) associated with the third individual 44c. Accordingly, the content presented on the display 40 is more useful and relevant to the individuals 44 viewing the display 40 at any given moment.

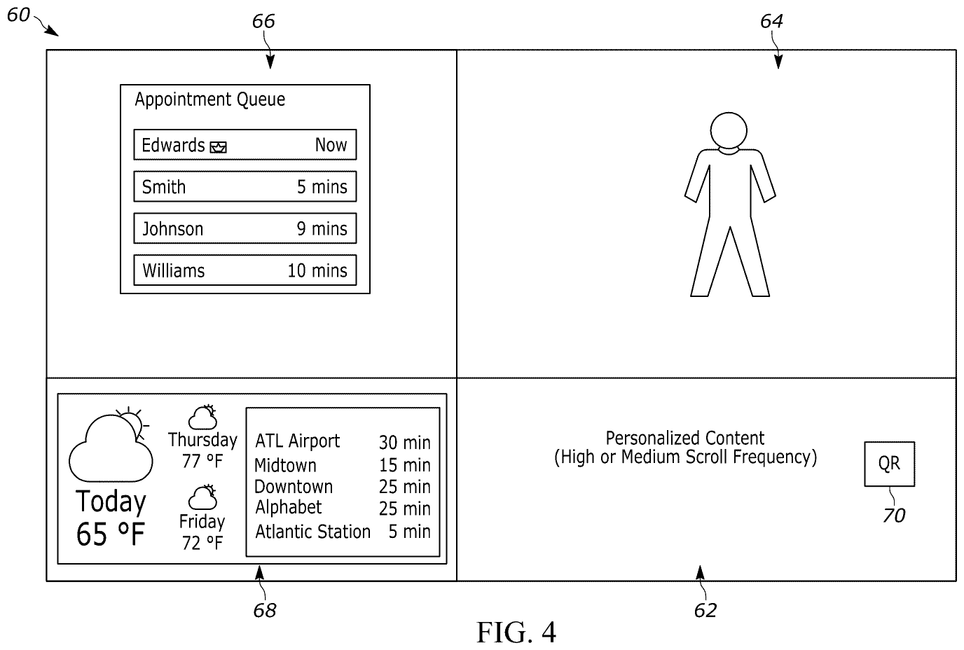

FIG. 4 shows information being simultaneously displayed in a plurality of regions on a display 60 that may be readily substituted for the digital display 24 (FIG. 1), the display 30 (FIG. 2) and/or the digital display 40 (FIGS. 3A-3C), already discussed. In the illustrated example, content 62 is presented in a first region of the display at a high or medium scroll frequency in response to a determination that one or more individuals are located at a far or medium distance, respectively, from the display 60. Additionally, one or more videos 64 (e.g., sporting event based on the time of year and/or day), an appointment queue 66 and weather information 68 may be presented in second, third and fourth regions, respectively, of the display 60 while the content 62 is presented in the first region. In an embodiment, the content 62 includes a scannable code 70 to provide instant access to products and/or services that are tailored to the individuals located at the far or medium distance from the display 60 (e.g., connecting digital exploration to in-lobby interactions).

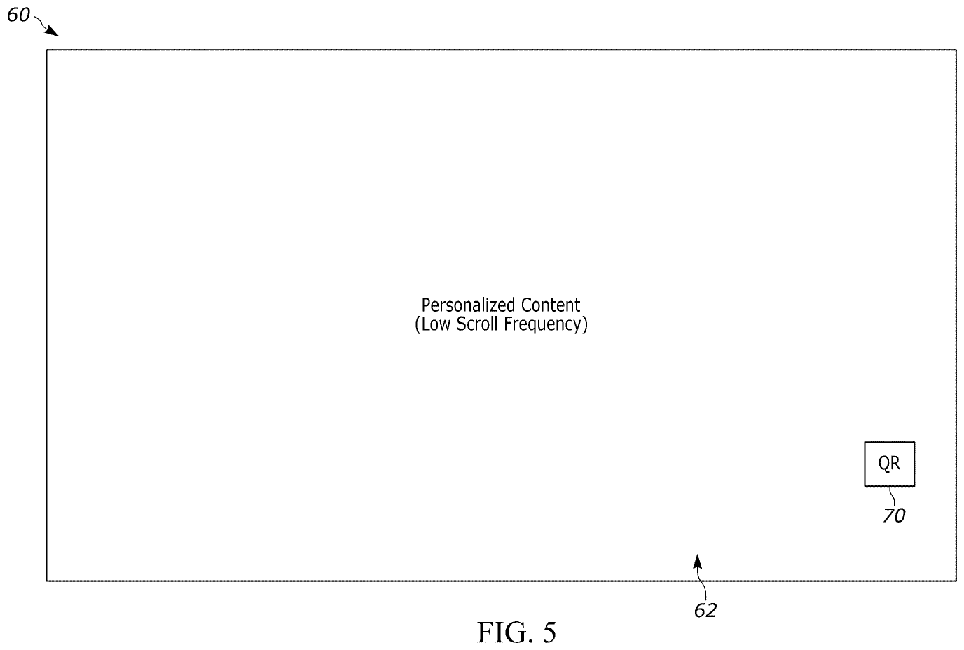

FIG. 5 shows the personalized content 62 being presented in the entirety of the display 60 at a third (e.g., relatively low) scroll frequency in response to a determination that individual(s) are located at a close distance from the display 60. In an embodiment, the personalized content 62 also includes the scannable code 70.

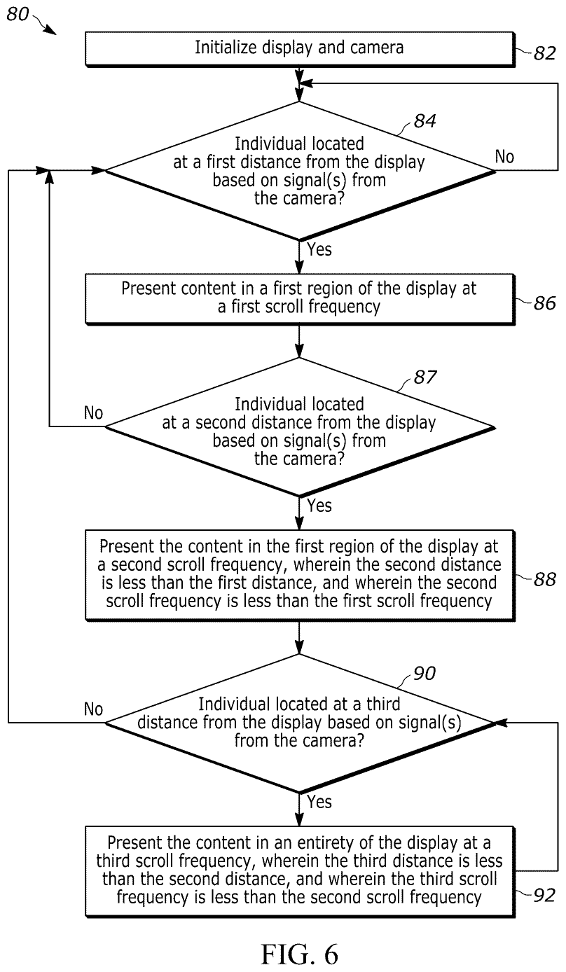

FIG. 6 shows a computer-implemented method 80 of operating a display. The computer-implemented method 80 may generally be implemented in a display such as, for example, the digital display 24 (FIG. 1), the display 30 (FIG. 2), the digital display 40 (FIGS. 3A-3C) and/or the display 60 (FIGS. 4-5), already discussed. More particularly, the computer-implemented method 80 may be implemented in one or more modules as a set of logic instructions stored in a machine- or computer-readable storage medium such as random access memory (RAM), read only memory (ROM), programmable ROM (PROM), firmware, flash memory, etc., in hardware, or any combination thereof. For example, hardware implementations may include configurable logic, fixed-functionality logic, or any combination thereof. Examples of configurable logic (e.g., configurable hardware) include suitably configured programmable logic arrays (PLAs), field programmable gate arrays (FPGAs), complex programmable logic devices (CPLDs), and general purpose microprocessors. Examples of fixed-functionality logic (e.g., fixed-functionality hardware) include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

Computer program code to carry out operations shown in the computer-implemented method 80 can be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 82 provides for initializing a display and camera (e.g., distance camera). Block 84 makes a first determination as to whether an individual is located at a first distance from the display (e.g., in a public viewing area) based on one or more signals from the camera. If not, the method 80 repeats block 84. Otherwise, block 86 presents content (e.g., personalized content) in a first region of the display at a first scroll frequency (e.g., ad update rate).

Block 87 makes a second determination as to whether the individual is located at a second distance from the display (e.g., in an interested viewing area) based on the signal(s) from the camera. If not, the method repeats block 84. Otherwise, block 88 presents the content in the first region at a second scroll frequency, wherein the second distance is less than the first distance, and wherein the second scroll frequency is less than the first scroll frequency.

Block 90 makes a third determination as to whether the individual is located at a third distance from the display based on the signal(s) from the camera. If not, the method 80 repeats block 84. Otherwise, block 92 presents the content in an entirety of the display at a third scroll frequency, wherein the third distance is less than the second distance, and wherein the third scroll frequency is less than the second scroll frequency.

In one example, block 92 includes modifying the content in the entirety of the display based on attribute data associated with the individual. For example, the attribute data may identify a client status of the individual, an appointment topic associated with the individual, etc., or any combination thereof. Moreover, blocks 84, 87 and 90 may determine the first, second and/or third distances, respectively, based on wireless triangulation data associated with the individual. In an embodiment, blocks 86, 88 and 92 can select the content based on appointment data from one or more of a kiosk or a remote application. A pre-trained AI LLM may also be used to generatively create personalized content in blocks 86, 88 and 92.

The method 80 therefore enhances performance at least to the extent that selecting and scrolling the content based on the proximity of individuals to the display renders the display more effective in delivering useful and/or relevant content to the individuals. Moreover, modifying the content based on attribute data and/or appointment data associated with the individuals further improves the usefulness and relevance of the content.

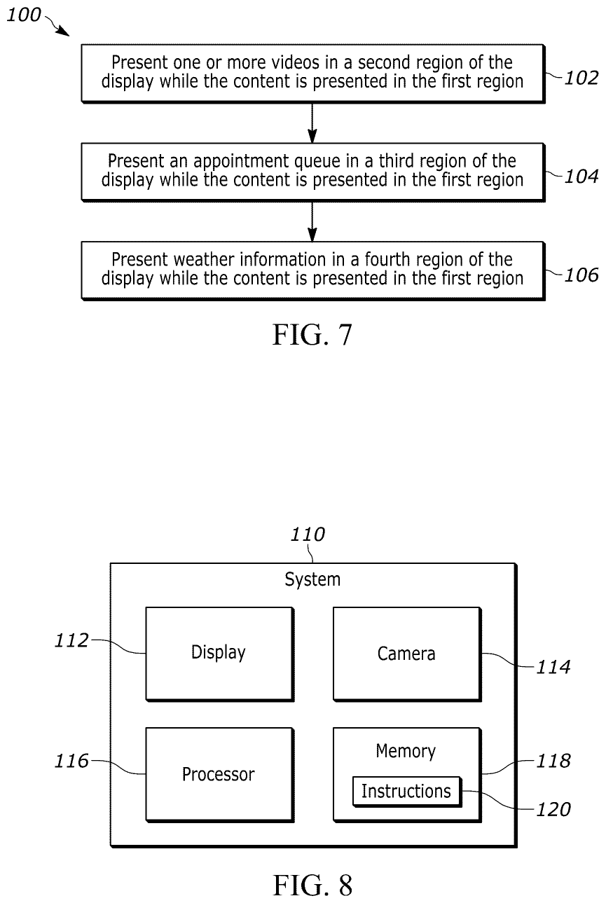

FIG. 7 shows another computer-implemented method 100 of operating a display. The computer-implemented method 100 may generally be implemented in conjunction with the method 80 (FIG. 6) in in a display such as, for example, the digital display 24 (FIG. 1), the display 30 (FIG. 2), the digital display 40 (FIGS. 3A-3C) and/or the display 60 (FIGS. 4-5), already discussed. More particularly, the computer-implemented method 100 may be implemented in one or more modules as a set of logic instructions stored in a machine-or computer-readable storage medium such as RAM, ROM, PROM, firmware, flash memory, etc., in hardware, or any combination thereof. For example, hardware implementations may include configurable logic, fixed-functionality logic, or any combination thereof.

Illustrated processing block 102 provides for presenting one or more videos in a second region of the display while the content is presented in the first region and block 104 provides for presenting an appointment queue in a third region of the display while the content is presented in the first region. Additionally, block 106 presents weather information in a fourth region of the display while the content is presented in the first region. The method 100 therefore further enhances performance at least to the extent that the video(s), appointment queue and/or weather information further improves the effectiveness of content delivery by the display, particularly when the video(s), appointment queue and weather information are tailored to the individual.

FIG. 8 shows a performance-enhanced system 110 having a display 112, a camera 114, a processor 116 and a memory 118 (e.g., system memory and/or mass storage). The display 112 may include a display such as, for example, the digital display 24 (FIG. 1), the display 30 (FIG. 2), the digital display 40 (FIGS. 3A-3C) and/or the display 60 (FIGS. 4-5), already discussed. In an embodiment, the memory 118 includes a plurality of executable program instructions 120, which when executed by the processor 116, cause the processor 116 and/or the system 110 to perform the method 80 (FIG. 6) and/or the method 100 (FIG. 7), already discussed.

Thus, execution of the instructions 120 causes the processor 116 and/or the system 110 to present content in a first region of the display 112, wherein the content is presented at a first scroll frequency in response to a first determination based on one or more signals from the camera 114 that an individual is located at a first distance from the display 112. Execution of the instructions 120 also causes the processor 116 and/or the system 110 to present the content in the first region of the display 112 at a second scroll frequency in response to a second determination based on the signal(s) from the display 112 that the individual is located at a second distance from the display 112. The second distance is less than the first distance and the second scroll frequency is less than the first scroll frequency. In an embodiment, execution of the instructions 120 further causes the processor 116 and/or the system 110 to present the content in an entirety of the display at a third scroll frequency in response to a third determination that the individual is located at a third distance from the display, wherein the third distance is less than the second distance, and wherein the third scroll frequency is less than the second scroll frequency.

The system 110 is therefore considered performance-enhanced at least to the extent that selecting and scrolling the content based on the proximity of individuals to the display renders the display more effective in delivering more useful and/or relevant content to the individuals. Moreover, modifying the content based on attribute data and/or appointment data associated with the individuals further improves the usefulness and relevance of the content.

Additionally, the technology described herein enables clients to determine their position in line and estimated wait time from a visual queue, which reduces uncertainty and improves the customer experience. The display also presents personalized product content, such as products that the customer has recently explored, wherein tailored offers are highlighted. A QR code can enable clients to instantly access details and take action on the offers. Additionally, real-time updates on local weather and traffic keep the content relevant and engaging.

Thus, the technology described herein connects digital behavior (e.g., product exploration) with in-branch touchpoints. The use of unique QR codes provides a measurable link between in-branch displays and customer actions.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

What is claimed is:

1. A system comprising:
a display;
a camera;
a processor coupled to the display and the camera; and
a memory coupled to the processor, the memory including a plurality of executable program instructions, which when executed by the processor, cause the processor to:
present content in a first region of the display, wherein the content is presented at a first scroll frequency in response to a first determination based on one or more signals from the camera that an individual is located at a first distance from the display, and
present the content in the first region of the display at a second scroll frequency in response to a second determination based on the one or more signals from the camera that the individual is located at a second distance from the display, wherein the second distance is less than the first distance, and wherein the second scroll frequency is less than the first scroll frequency.

2. The system of claim 1, wherein the executable program instructions, when executed, further cause the processor to present the content in an entirety of the display at a third scroll frequency in response to a third determination based on the one or more signals from the camera that the individual is located at a third distance from the display.

3. The system of claim 2, wherein the third distance is less than the second distance.

4. The system of claim 3, wherein the third scroll frequency is less than the second scroll frequency.

5. The system of claim 4, wherein the executable program instructions, when executed, further cause the processor to modify the content in the entirety of the display.

6. The system of claim 4, wherein the content is modified in the entirety of the display based on attribute data associated with the individual.

7. The system of claim 6, wherein the attribute data is to identify a client status of the individual.

8. The system of claim 6, wherein the attribute data is to identify an appointment topic associated with the individual.

9. The system of claim 4, wherein the executable program instructions, when executed, further cause the processor to determine the first distance, the second distance and the third distance.

10. The system of claim 9, wherein the first distance, the second distance and the third distance are determined based on wireless triangulation data associated with the individual.

11. The system of claim 1, wherein the executable program instructions, when executed, further cause the processor to select the content based on appointment data from a remote kiosk.

12. The system of claim 1, wherein the executable program instructions, when executed, further cause the processor to select the content based on appointment data from a remote application.

13. The system of claim 1, wherein the executable program instructions, when executed, further cause the processor to present one or more videos in a second region of the display while the content is presented in the first region.

14. The system of claim 13, wherein the executable program instructions, when executed, further cause the processor to present an appointment queue in a third region of the display while the content is presented in the first region.

15. The system of claim 13, wherein the executable program instructions, when executed, further cause the processor to present weather information in a fourth region of the display while the content is presented in the first region.

16. The system of claim 13, wherein the executable program instructions, when executed, further cause the processor to present traffic information in a fourth region of the display while the content is presented in the first region.

17. The system of claim 1, wherein the content includes a scannable code to provide instant access to products and/or services tailored to individuals located at a predefined distance from the display.

18. The system of claim 17, wherein the scannable code comprises a QR code.

19. At least one computer readable storage medium comprising a plurality of executable program instructions, which when executed by a processor, cause the processor to:
present content in a first region of a display, wherein the content is presented at a first scroll frequency in response to a first determination based on one or more signals from a camera that an individual is located at a first distance from the display; and
present the content in the first region of the display at a second scroll frequency in response to a second determination based on the one or more signals from the camera that the individual is located at a second distance from the display, wherein the second distance is less than the first distance, and wherein the second scroll frequency is less than the first scroll frequency.

20. A method comprising:
presenting content in a first region of a display, wherein the content is presented at a first scroll frequency in response to a first determination based on one or more signals from a camera that an individual is located at a first distance from the display; and
presenting the content in the first region of the display at a second scroll frequency in response to a second determination based on the one or more signals from the camera that the individual is located at a second distance from the display, wherein the second distance is less than the first distance, and wherein the second scroll frequency is less than the first scroll frequency.
